(19) United States
(12) Patent Application Publication
(10) Pub. No.: US 2010/0287407 A1
(43) Pub. Date: Nov. 11, 2010

(54) Computer Storage Synchronization and Backup System

(75) Inventors: Amarnath Basu, Bangalore (IN); Sabi Shaw Bhaskaran, Bangalore (IN); Ravi Krishna Madipadaga, Bangalore (IN); Saikat Mukherjee, Bangalore (IN)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., Malvern, PA (US)

(21) Appl. No.: 12/628,769

(22) Filed: Dec. 1, 2009

Related U.S. Application Data
(60) Provisional application No. 61/175,633, filed on May 5, 2009.

(51) Int. Cl. G06F 11/14; G06F 12/00; G06F 12/16; G06F 11/00

(52) U.S. Cl. 714/6; 711/162; 707/695; 714/E11.118; 711/E12.001; 711/E12.103

(57) ABSTRACT

A computer data protection system comprises a primary computer storage medium, a backup computer storage medium and a storage management system. The storage management system, in response to a command to write data to a file in the primary computer storage medium, initiates storage of data in a file in the backup computer storage medium and a file in the primary computer storage medium. The storage management system delays returning acknowledgement of completion of an operation to write the data to the primary computer storage medium until completion of storage of the data in the file in the backup computer storage medium and the file in said primary computer storage medium.

This is a non-provisional application of provisional application Ser. No. 61/175,633 filed May 5, 2009, by A. Basu et al.

### FIELD OF THE INVENTION

This invention concerns a computer data protection system for managing storage of data in a file in a backup computer storage medium and a file in a primary computer storage medium.

### BACKGROUND OF THE INVENTION

File replication and synchronization (FRS) systems are used to communicate created files, updates and deletions to a document or program made at a source location to a designated target location. A location may be a folder or a logical disk volume, for example. By sending document changes to a target location, if a source location becomes unavailable, the target location is used to provide a document with the latest updates resulting in reduced downtime. In known systems scheduled backups ensure high document availability, but changes made to a document between, a last backup time and the time when a source location becomes unavailable, are lost. This loss can be minimized by increasing the backup frequency but there is still a time window where updated files are unavailable at the target location in the event of a failure at the source location.

Known systems for ‘continuous’ file replication and synchronization (FRS) between a source location on a primary computer (where files are edited) and a target location on a backup computer (where the backup files are stored) connected over a data network, are used to continuously communicate changes at a source location to a target location. However, the continuous nature of updates does not guarantee 100% availability of updated files at the target location if the source location is not available. Known systems using continuous updates fail to guarantee 100% availability of a file in a backup computer in the event of a hardware or software failure at a primary computer.

Known systems typically use an asynchronous, event driven mechanism to propagate changes continuously from a primary computer to a backup computer and hence fail to achieve 100% availability. The asynchronous nature of the change propagation results in a time window (failure time window or FTW) where the changes to a file have been applied on the primary computer and are yet to be applied on the backup computer (i.e., changes are in an FRS queue and subsequently in a change execution queue at a backup computer) and a failure during this time results in irrecoverable inconsistency between the primary and backup computer. Consider a file write operation invoked by an application at a source location which is being monitored by a continuous FRS service. A typical sequence of events which occurs and the window for failure, during which a failure at a primary computer results in data loss at the backup computer is shown in FIG. 1. Scheduled backups result in a larger FTW compared to that required by continuous data protection systems.

FIG. 1 shows the sequence of events which occur over time in a known typical continuous data protection (CDP) service 101. CDP service 101 first registers 103 with the OS for file-system events. An event that the CDP registers for in this example is a write event (Register for write event). In response to an application making write request 105 to the OS (Write), the data is written 107 to the primary computer disk (Write) and an acknowledgement 109 is sent to the OS (Done). The OS generates an event (Event) 111 for which the CDP service has registered and sends a write acknowledgement 113 to the Application (Done). The CDP stores the event it received from the OS into its queue, processes the event and copies the data to the backup computer disk (Copy to Backup) 115 and receives an acknowledgement 117 from the Backup computer disk (Done) once the data is copied. If a failure occurs at the primary computer during the Failure Time Window 120, the written data is not available at the Backup computer disk.

Some known hardware systems, including RAID (Redundant Array of Inexpensive Disks), failover clustering, NAS (Network Attached Storage), SAN (Storage Area Network) systems, achieve full (100%) availability in case of a primary computer failure. RAID, NAS, SAN and failover clustering provide means of achieving 100% availability in the event of a failure at the primary computer in that the data is available at the backup computer (or disk) but are often expensive and cumbersome. A system according to invention principles addresses these deficiencies and associated problems.

### SUMMARY OF THE INVENTION

A system advantageously performs unitary step synchronous file replication and synchronization to backup computer data providing 100% availability at the backup computer and to eliminate data loss in the event of a primary computer failure, at relatively low cost compared to hardware system. A computer data protection system comprises a primary computer storage medium, a backup computer storage medium and a storage management system. The storage management system, in response to a command to write data to a file in the primary computer storage medium, initiates storage of data in a file in the backup computer storage medium and a file in the primary computer storage medium. The storage management system delays returning acknowledgement of completion of an operation to write the data to the primary computer storage medium until completion of storage of the data in the file in the backup computer storage medium and the file in said primary computer storage medium.

### BRIEF DESCRIPTION OF THE DRAWING

FIG. 1 illustrates a sequence of events which occur over time in a known typical continuous data protection (CDP) service.

FIG. 2 shows a computer data protection system, according to invention principles.

FIG. 3a shows a source function in an application calling a target function in a known system.

FIG. 3b shows performing file updates (at the primary and backup storage media) in one unitary step, ensuring both primary and backup media are updated before returning an application function call.

FIG. 4 shows a sequence of events which occur over time in a synchronous, file replication service system, according to invention principles.

FIG. 5 shows linking of library functions used in performing file updates (at the primary and backup storage media) in one unitary step, ensuring both primary and backup media are updated before returning an application function call.

FIG. 6 shows an NTFS transaction manager used to control file recall and file version rollback in the event of a failure.

FIG. 7 shows a flowchart of a process used by a computer data protection system, according to invention principles.

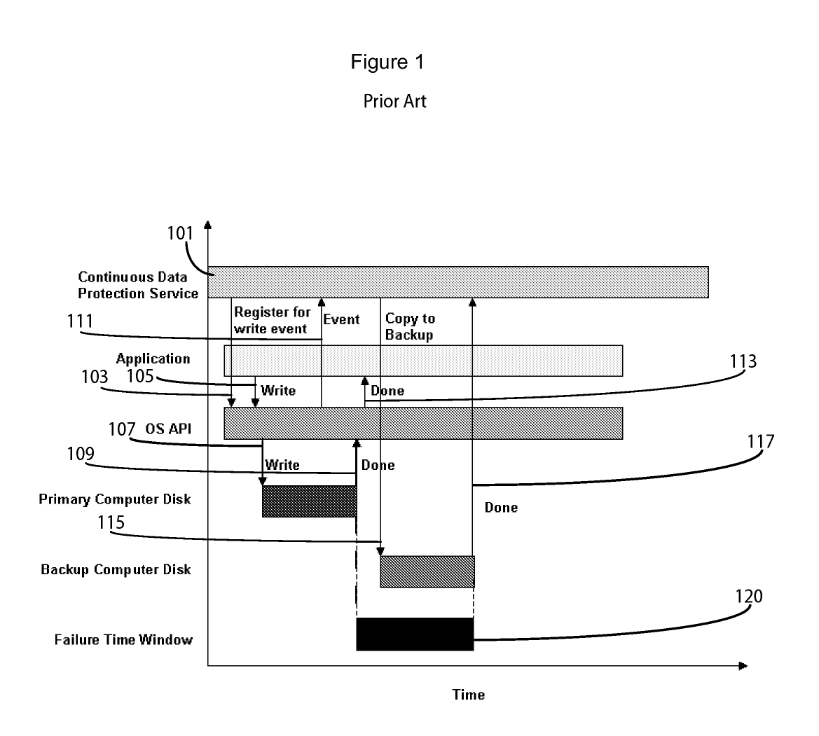

### DETAILED DESCRIPTION OF THE INVENTION

A system synchronously communicates data representing document updates to a target location on a backup computer eliminating a time window which potentially causes lost update information in the event of a computer system failure. The system ensures 100% availability of a file in a backup computer, if it was successfully created, changed or deleted at a source location on a primary computer. The inventors have advantageously recognized that by performing file update operations in primary and backup computers in a single unitary step eliminates a failure time window that may result in loss data upon a system failure. The system provides document update information to both the primary and backup computer system in one step, so that either both the primary and backup computer systems are updated or neither system is updated in response to occurrence of a system failure.

In one embodiment, the system performs document file updates at both the primary and the backup computer in one single unitary step from the perspective of a storage management application and operating system, to eliminate a failure time window. At the application level, a storage management application is informed of a success or failure only if updates to both the primary and backup computer system are successful or a failure. From the system perspective, if there is an error during either of the updates, both document copies in the primary and backup computer systems are replaced with versions prior to the updates by the OS (operating system) and the storage management application is informed about the failure of the operation. The OS may incorporate at least a portion of the storage management system to perform the version replacement.

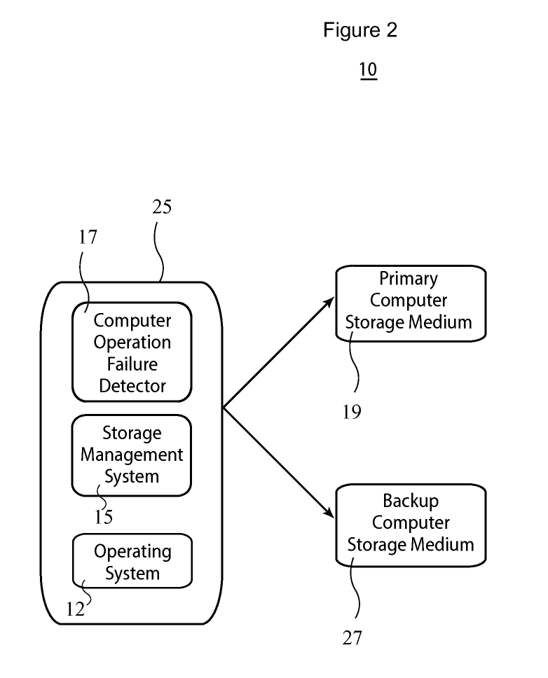

FIG. 2 shows computer data protection system 10 including primary computer storage medium 19, backup computer storage medium 27 and at least one processing device 25 comprising a computer, server, logic array or other device. At least one processing device 25 includes operating system 12, computer operation failure detector 17 and storage management system 15. Storage management system 15, in response to a command to write data to a file in primary computer storage medium 19, initiates storage of data in a file in backup computer storage medium 27 and a file in primary computer storage medium 19. Storage management system 15, delays returning acknowledgement of completion of an operation to write the data to primary computer storage medium 19 until completion of storage of the data in the file in backup computer storage medium 27 and the file in the primary computer storage medium 19. In response to a computer operation failure (e.g. during a write operation) being determined by computer operation failure detector 17, storage management system 15 indicates a last updated version of the file is available for use and uses the last updated version of the file instead of the latest updated version.

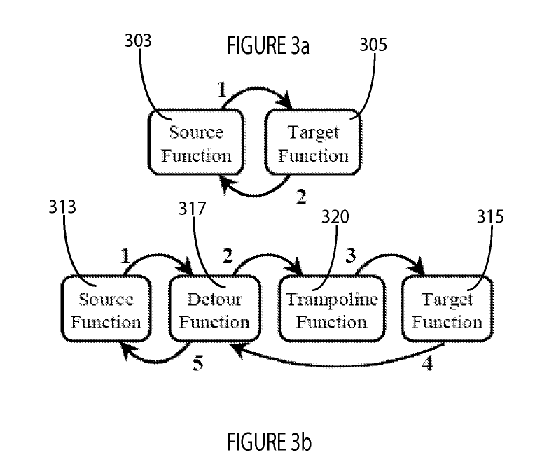

FIG. 3a shows a known system such as a Windows API in which a source function 303 in an application calls a target function 305 which responds to the source function. In contrast, FIG. 3b shows storage management system 15 (FIG. 2) performing file updates (at the primary and backup storage media) in one unitary step, ensuring both primary and backup media are updated before returning an application function call. In order to ensure that both the document file updates (to the primary and backup computer media 19 and 27) are performed in one unitary step, an operating system link is used for file modification functions provided by an API (Application Programming Interface) in OS 12 (FIG. 2). In response to a document file update function link being activated, a system service function is activated in storage management system 15 ensuring both the primary and backup computer are updated before returning an application function call. Source function 313 calls detour function 317 which calls trampoline function 320 which in turn calls target function 315. Target function 315 responds to source function 313 via detour function 317. In one embodiment, storage management system 15 provides the links between the elements 313, 317, 320 and 315 using a Windows Detours Library.

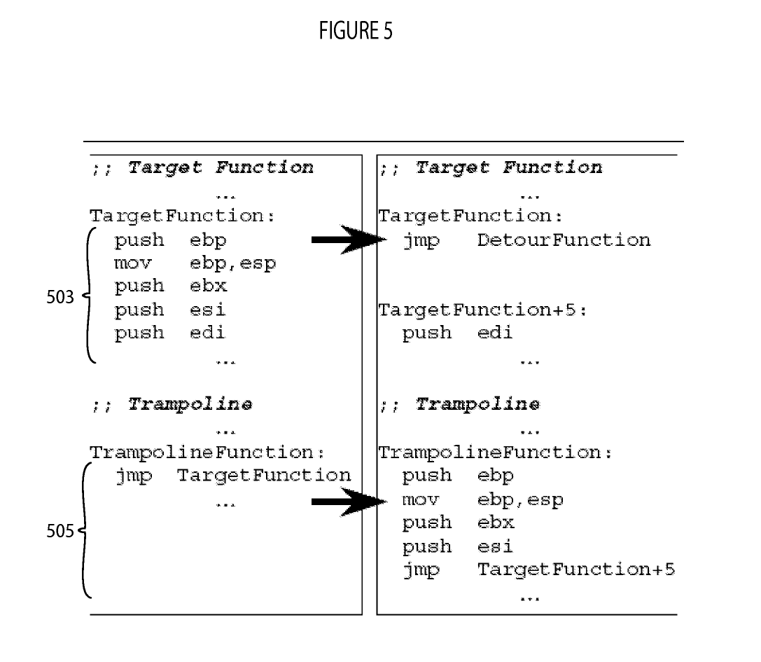

FIG. 5 illustrates use of a Windows Detours library function in providing links between the elements 313, 317, 320 and 315 (FIG. 3). Specifically, in response to a call by source function 313 to target function 315, storage management system 15 executes instructions 503 to initiate execution of detour function 317, for example. Similarly, trampoline function 320 executes instructions 505 to initiate execution of target function 315, for example.

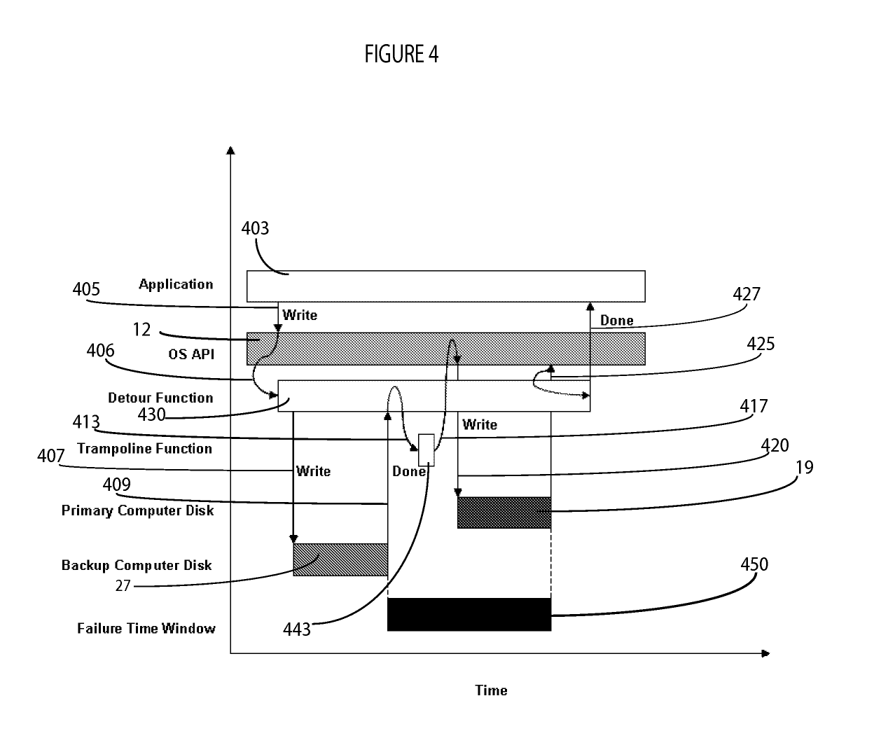

FIG. 4 shows a sequence of events which occur over time in a synchronous, file replication service system in storage management system 15. In response to application 403 making a write request 405 to OS 12, storage management system 15 uses a detours library to call detour function 430 via link 406 and writes 407 the data to backup computer storage medium 27. The acknowledgement 409 for the write is returned to detour function 430 which calls 413 the trampoline function 443 to initiate a jump to the intended write 417 function using an OS 12 write API to write 420 the data to primary computer storage medium 19 and return acknowledgement 425 to the OS 12 API and to application 403 (acknowledgement 427). The sequence involves failure time window 450. However the system ensures the detour function is a unitary operation (using Windows NTFS and Distributed Transaction Manager in one embodiment, for example). Therefore, the write operation occurs either at both the primary and backup storage media, or at none at all.

However, as is indicated in the sequence of events of FIG. 4, although the sequence ensures updates are made to both the primary computer storage medium and backup storage medium before application 403 is informed of the write operation, the updated files in the primary computer storage medium and backup storage medium can be at inconsistent states in the event of a failure during failure time window 450. System 10 employs a rollback function to ensure that the files are rolled back to a previous version in the event of a failure during failure time window 450. The system uses NTFS (Windows NT file system) compatible Transaction File System ACID (Atomic, Consistent, Isolated, Durable) properties to ensure that both the files can be rolled back to their previous version and original condition in the event of failure during failure time window 450.

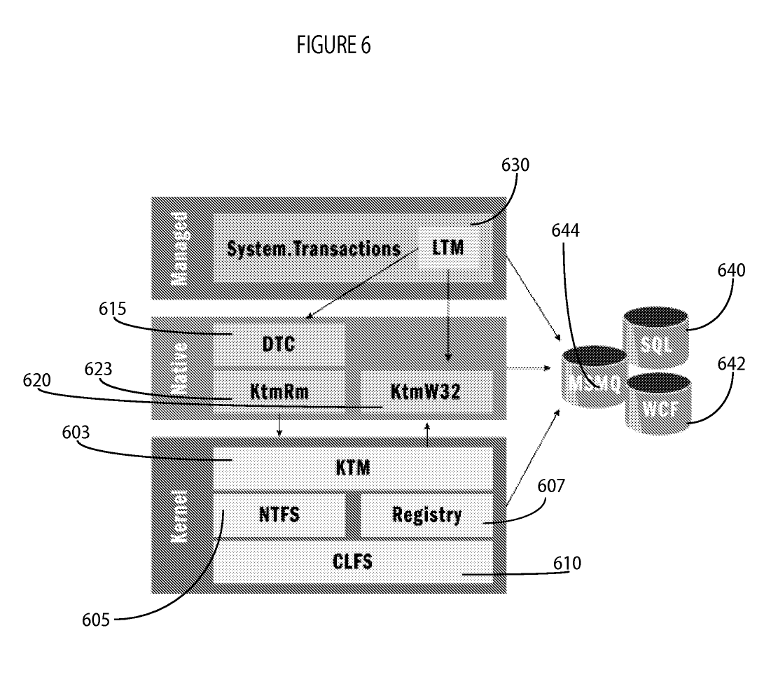

FIG. 6 shows an NTFS transaction manager used to control file recall and file version rollback in the event of a failure during failure time window 450. System 10 uses Kernel Transaction Manager 603 to create transaction files and ensures that rollbacks are possible in the event of the failure of the unitary step. Kernel Transaction Manager 603 controls file recall and rollback in NT file system 605 using object and file registry 607 and common log file system (CLFS) 610, as known. Kernel Transaction Manager 603 in conjunction with lightweight transaction manager (LTM) 630 and distributed transaction coordinator (DTC) 615, controls SQL (structured query language) transactions 640, (MSMQ) (Microsoft message query) transactions 644 and WCF (Windows communication foundation) transactions 642. Distributed transaction coordinator (DTC) 615 employs KtmRm 623 and KtmW32 620 processes in transaction recall and rollback, as known.

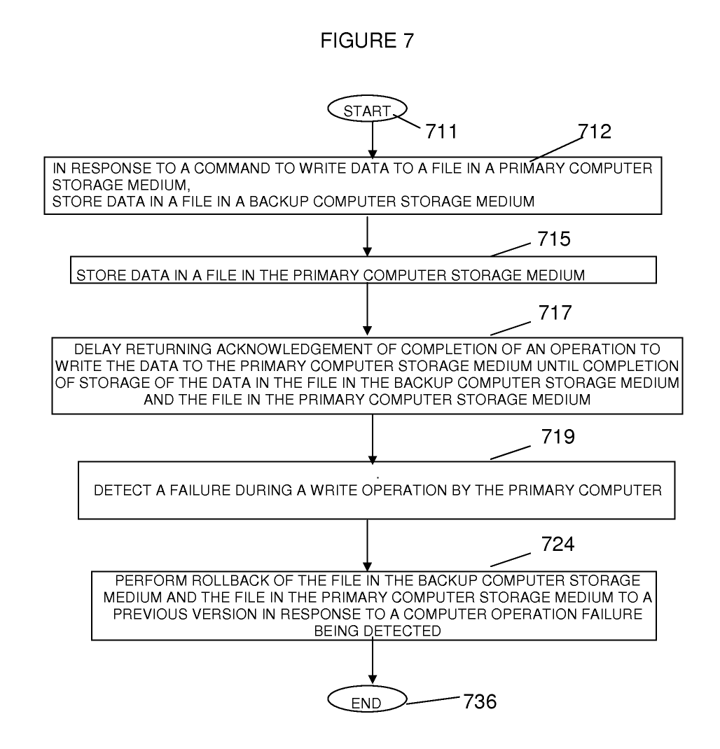

FIG. 7 shows a flowchart of a process used by the computer data protection system of system 10 (FIG. 2). In step 712 following the start at step 711, in response to a command to write data to a file in primary computer storage medium 19, storage management system 15 stores data in a file in a backup computer storage medium 27 and in step 715 stores data in a file in primary computer storage medium 19. In step 717 storage management system 15 delays returning acknowledgement of completion of an operation to write the data to primary computer storage medium 19 until completion of storage of the data in the file in backup computer storage medium 27 and the file in primary computer storage medium 19. In step 719, computer operation failure detector 17 detects a failure during a write operation by the primary computer. Storage management system 15 in step 724 indicates a previous version of the file is available for use and performs rollback of the file in backup computer storage medium 27 and the file in primary computer storage medium 19 to a previous version in response to a computer operation failure being detected by detector 17.

In one embodiment, the file in backup computer storage medium 27 and the file in primary computer storage medium 19 are a latest version of the file. Also, in response to a primary computer operation failure occurring during a write operation and being determined by detector 17, storage management system 15 initiates storage of (and uses) a previous version of the file as the file in backup computer storage medium 27 and the file in primary computer storage medium 19. Further, an NTFS compatible transaction manager application in storage management system 15 initiates storage of a previous version of the file as the file in backup computer storage medium 27 and the file in primary computer storage medium 19. In one embodiment, storage management system 15 initiates overwrite of the file in backup computer storage medium 27 and the file in the primary computer storage medium 17 with a previous version of the file. Further, storage management system 15 initiates storage of data in backup computer storage medium 27 prior to storage in primary computer storage medium 19. Alternatively, storage management system 15 initiates storage of data in primary computer storage medium 19 prior to storage in the backup computer storage medium 27 or initiates storage of data in primary computer storage medium 19 concurrently with storage in backup computer storage medium 27, for example. The process of FIG. 7 terminates at step 736.

A processor as used herein is a computer, processing device, logic array or other device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a controller or microprocessor, for example, and is conditioned using executable instructions to perform special purpose functions not performed by a general purpose computer. A processor may be coupled (electrically and/or as comprising executable components) with any other processor enabling interaction and/or communication there-between. A display processor or generator is a known element comprising electronic circuitry or software or a combination of both for generating display images or portions thereof.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

The system and processes of FIGS. 2, 4 and 7 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. The system advantageously performs unitary step synchronous file replication and synchronization to backup a computer resulting in substantially 100% availability at the backup computer and eliminate data loss in the event of a primary computer failure. Further, the processes and applications may, in alternative embodiments, be located on one or more (e.g., distributed) processing devices on a network linking the units of FIG. 2. Any of the functions and steps provided in FIGS. 2, 4 and 7 may be implemented in hardware, software or a combination of both.

What is claimed is:

1. A computer data protection system, comprising:
a primary computer storage medium;
a backup computer storage medium; and
a storage management system for, in response to a command to write data to a file in said primary computer storage medium,
initiating storage of data in a file in said backup computer storage medium and a file in said primary computer storage medium and
delaying returning acknowledgement of completion of an operation to write the data to said primary computer storage medium until completion of storage of the data in said file in said backup computer storage medium and said file in said primary computer storage medium.

2. A system according to claim 1, including
a computer operation failure detector and
in response to a computer operation failure determined by said detector, said storage management system indicates a last updated version of said file is available for use.

3. A system according to claim 2, wherein
said computer operation failure detector detects said computer operation failure during a write operation determined by said detector.

4. A system according to claim 2, wherein
said file in said backup computer storage medium and said file in said primary computer storage medium are a latest version of said file and
in response to a primary computer operation failure occurring during a write operation, said primary computer operation failure being determined by said detector, said storage management system uses a previous version of said file instead of said latest updated version.

5. A system according to claim 1, wherein
said storage management system initiates storage of data in said backup computer storage medium prior to storage in said primary computer storage medium.

6. A system according to claim 1, wherein
said storage management system at least one of, (a) initiates storage of data in said primary computer storage medium prior to storage in said backup computer storage medium and (b) initiates storage of data in said primary computer storage medium concurrently with storage in said backup computer storage medium.

7. A system according to claim 2, wherein
said file in said backup computer storage medium and said file in said primary computer storage medium are a latest version of said file and
in response to a primary computer operation failure occurring during a write operation, said primary computer operation failure being determined by said detector, said storage management system initiates storage of a previous version of said file as said file in said backup computer storage medium and said file in said primary computer storage medium

8. A system according to claim 7, wherein
said storage management system initiates overwrite of said file in said backup computer storage medium and said file in said primary computer storage medium with a previous version of said file

9. A system according to claim 2, wherein
said file in said backup computer storage medium and said file in said primary computer storage medium are a latest version of said file and
in response to a primary computer operation failure occurring during a write operation, said primary computer operation failure being determined by said detector, an NTFS compatible transaction manager application in said storage management system initiates storage of a previous version of said file as said file in said backup computer storage medium and said file in said primary computer storage medium

10. A computer data protection system, comprising:
a primary computer storage medium;
a backup computer storage medium;
a computer operation failure detector for detecting a failure during a write operation by said primary computer; and
a storage management system for,
in response to a command to write data to a file in said primary computer storage medium,
initiating storage of data in a file in said backup computer storage medium and a file in said primary computer storage medium and
delaying returning acknowledgement of completion of an operation to write the data to said primary computer storage medium until completion of storage of the data in said file in said backup computer storage medium and said file in said primary computer storage medium and
in response to a computer operation failure determined by said detector, said storage management system initiates rollback of said file in said backup computer storage medium and said file in said primary computer storage medium to a previous version.

11. A system according to claim 10, wherein
said storage management system indicates a previous version of said file is available for use.

12. A method for protecting data in a computer system, comprising the activities of:
in response to a command to write data to a file in a primary computer storage medium,
storing data in a file in a backup computer storage medium and
storing data in a file in said primary computer storage medium and
delaying returning acknowledgement of completion of an operation to write the data to said primary computer storage medium until completion of storage of the data in said file in said backup computer storage medium and said file in said primary computer storage medium.

13. A method according to claim 12, including the steps of
detecting a failure during a write operation by said primary computer; and
performing rollback of said file in said backup computer storage medium and said file in said primary computer storage medium to a previous version in response to a computer operation failure being detected by said detector.
